(19) United States
(12) Patent Application Publication
(10) Pub. No.: US 2004/0104897 A1
(43) Pub. Date: Jun. 3, 2004

(54) Foldable keyboard

(75) Inventors: Isao Mochizuki, Kaizu-gun (JP); Takeyuki Takagi, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, NAGOYA-SHI (JP)

(21) Appl. No.: 10/717,486

(22) Filed: Nov. 21, 2003

(30) Foreign Application Priority Data
Dec. 2, 2002 (JP) 2002-350329
Dec. 2, 2002 (JP) 2002-350354

(51) Int. Cl. G09G 5/00

(52) U.S. Cl. 345/168

(57) ABSTRACT

A lower end of one of two support members 80 is pivotally connected to a support wall 81 having a slant face 81A in a first keyboard unit 3 and an upper end is pivotally connected to one plate part of a hinge joint 92. A lower end of the other support member 80 is pivotally connected to a support wall 83 having a slant face 83A in a second keyboard unit 4 and an upper end is pivotally connected to the other plate part of the hinge joint 92. At the time when the first and second keyboard units 3 and 4 are fully opened in a horizontal position, the support members 80 are set up in a standing orientation tilting at an angle of 45° with the operating plane of a keyboard 1.

### BACKGROUND OF THE INVENTION

1. Field of the Invention

The present invention relates to a foldable keyboard with superior portability and good operationality in use and, more particularly, to a foldable keyboard including support members for supporting a portable device such as a PDA which is used in connected relation with the keyboard, the support members being able to be stored in storage parts in two keyboard units when the keyboard is folded and to be set up from the storage areas into a standing orientation for the PDA or the like through one-touch operation, in synchronization with an unfolding operation of the folded keyboard units.

Furthermore, the present invention relates to a foldable keyboard including a connector unit to be connected with a portable device such as a PDA, the connector unit being able to be stored in two keyboard units when the keyboard is folded and to be moved to a center position of the keyboard through one-touch operation, in synchronization with an unfolding operation of the folded keyboard units.

2. Description of Related Art

Heretofore, there have been proposed various types of foldable keyboards including two separate keyboard units rotatably connected with each other. When the keyboard is not in use, the keyboard units are superposed one on top of the other into a folded compact state, thus making it easy to carry anywhere. When in use, on the other hand, the keyboard units are opened from the folded state, thus providing high operationality equivalent to standard keyboards.

For example, Japanese patent No. 3,201,456 (corresponding to Japanese patent unexamined publication No. Hei 9-34612; pages 2-3 and FIGS. 1 through 10) and Japanese patent No. 3,254,658 (corresponding to Japanese patent unexamined publication No. Hei 9-34611; pages 2-3 and FIGS. 1 through 11) each disclose a foldable keyboard including an enclosure and a keyboard, both being divided into two at respective centers in longitudinal directions, which are rotatably engage with each other through a joint arm, thereby making the keyboard freely foldable.

Moreover, Japanese patent unexamined publication No. 2000-56904 (pages 3-5 and FIGS. 1 through 12) discloses a foldable keyboard in which two separate keyboards, at least one of which is slidably supported in a support plate, are rotatably connected to both sides of a back plate via the support plate.

In each keyboard mentioned above, the two separate keyboard units are rotatably connected with each other so that they are superposed during nonuse to enhance portability of the keyboard and they are rotated outwards to be unfolded, allowing operation with high operationality equal to standard keyboards.

Meanwhile, portable devices such as a PDA and a cell phone have come into wide use recently. Downsizing of the portable devices of this type has therefore been desired for enhancing portability. As a result, an input part with which various information are input has to be arranged in a very small area. If such input part contains a plurality of keys, for instance, each key must be constructed to be as small as possible, which leads to low key operationality. In addition, the number of keys contained in the input part is smaller than standard keyboards, so that users or operators are likely forced to operate such keys small in number in a complicated key-operating manner. The above mentioned foldable keyboards have been proposed in consideration of the operationality of various portable devices.

However, the keyboards in the above Japanese patent No. 3,201,456 (JP-A-9/34612), Japanese patent No. 3,254,658 (JP-A-9/34611), and JP-A-2000/56904 have been devised without taking connection with portable devices such as a PDA into consideration and without providing any supporting structures for supporting the portable devices.

### SUMMARY OF THE INVENTION

The present invention has been made in view of the above circumstances and has an object to overcome the above problems and to provide a foldable keyboard including support members for supporting a portable device such as a PDA which is used in connected relation with the keyboard, the support members being able to be stored in storage parts in two keyboard units when the keyboard is folded and to be set up from the storage areas into a standing orientation for the PDA or the like through one-touch operation, in synchronization with an opening operation of the folded keyboard units.

Another object of the present invention is providing a foldable keyboard including a connector unit to be connected with a portable device such as a PDA, the connector unit being able to be stored in two keyboard units when the keyboard is folded and to be moved to a center position of the keyboard through one-touch operation, in synchronization with an opening operation of the folded keyboard units.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a foldable keyboard including a first keyboard unit, a second keyboard unit, and a rotational connecting part provided between the first and second keyboard units, so that the first and second keyboard units are rotated about the connecting part to come apart from each other into an unfolded, horizontally arranged state for use of the keyboard, while the first and second keyboard units are rotated about the connecting part to come close to each other into a closed, folded state for nonuse of the keyboard, the keyboard including: a first support member having a first end and a second end, the first end being pivotally connected to a back wall of the first keyboard unit; a second support member having a first end and a second end, the first end being pivotally connected to a back wall of the second keyboard unit; wherein the second ends of the first and second support members are pivotally connected with each other, and the first and second support members are set up in a standing orientation in synchronization with the rotation of the first and second keyboard units in a direction which they come apart from each other.

According to another aspect, the invention provides a foldable keyboard including a first keyboard unit, a second keyboard unit, and a rotational connecting part provided between the first and second keyboard units, so that the first and second keyboard units are rotated about the connecting part to come apart from each other into an unfolded, horizontally arranged state for use of the keyboard, while the first and second keyboard units are rotated about the connecting part to come close to each other into a closed, folded state for nonuse of the keyboard, the keyboard including: a connector unit for connecting the keyboard to a portable device; a first connector storage part formed in the first keyboard unit; a second connector storage part formed in the second keyboard unit and for storing, in conjunction with the first connector storage part, the connector unit; a first support link which connects the first connector storage part to the connector unit; a second support link which connects the second connector storage part to the connector unit; wherein the connector unit is moved toward the rotational connecting part from the first and second connector storage parts in synchronization with rotation of the first and second keyboard units in a direction which they come apart from each other, and the connector unit is placed above the rotational connecting part in a substantial center of the keyboard when the first and second keyboard units are rotated into the horizontally arranged state.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a partially exploded, perspective view of a foldable keyboard in an embodiment, in which a connector unit and a supporting structure are omitted;

FIG. 2 is a perspective back view of the keyboard, in which the connector unit and the supporting structure are shown in exploded condition;

FIG. 3 is a perspective view of the keyboard in which a first and second keyboard units are superposed, or folded;

FIG. 4 is a side view of the keyboard of FIG. 3;

FIG. 5 is a partially enlarged, sectional view of the keyboard of FIG. 3;

FIG. 6 is a perspective view of the keyboard in which the first and second keyboard units are slightly opened;

FIG. 7 is a side view of the keyboard of FIG. 6;

FIG. 8 is a perspective view of the keyboard in which the first and second keyboard units are further opened from the state in FIG. 6;

FIG. 9 is a side view of the keyboard of FIG. 8;

FIG. 10 is a perspective view of the keyboard in which the first and second keyboard units are fully opened into a horizontally arranged state;

FIG. 11 is a side view of the keyboard of FIG. 10;

FIG. 12 is a perspective back view of the keyboard in which a PDA connected with the keyboard is supported by a support member; and

FIGS. 13A-13C are enlarged explanatory views showing a relation between gear teeth parts; specifically, FIG. 13A shows the gear teeth parts in separate relation for convenience of explanation; FIG. 13B shows the gear teeth sections parts in engaged relation; and FIG. 13C shows the gear teeth parts in engaged relation while the first and second keyboard units are superposed one on top of the other in the folded keyboard.

### DETAILED DESCRIPTION OF THE PREFERRED EMBODIMENTS

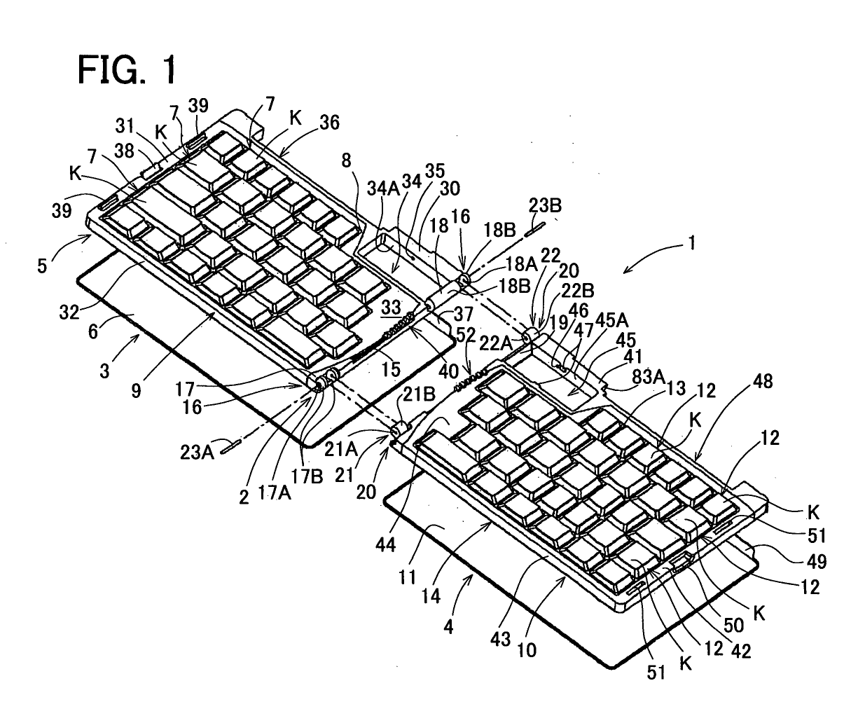

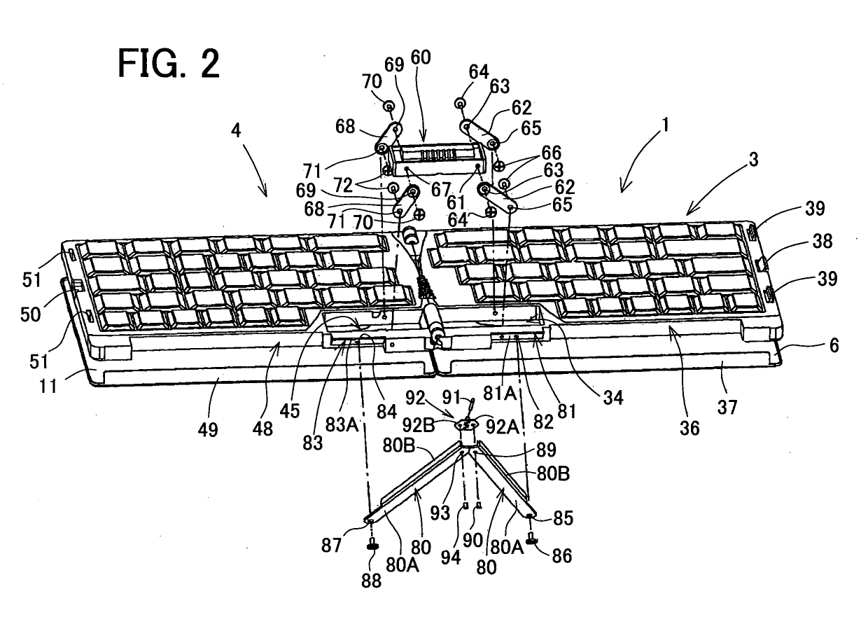

A detailed description of a preferred embodiment of a foldable keyboard embodying the present invention will now be given referring to the accompanying drawings. The schematic structure of the foldable keyboard in the present embodiment is first explained with reference to FIGS. 1 and 2. FIG. 1 is a partially exploded, perspective view of the foldable keyboard in which a connector unit and a supporting structure are omitted; and FIG. 2 is a perspective back view of the keyboard in which the connector unit and the supporting structure are shown in exploded condition.

In FIG. 1, the keyboard 1 basically includes a first keyboard unit 3 and a second keyboard unit 4 which are rotatably connected with each other through a rotational connecting part 2.

The first keyboard unit 3 is constructed of a key placement unit 5 and a first base plate 6 made of a metallic, e.g. aluminum, thin plate which is fixed to the undersurface of the key placement unit 5. This key placement unit 5 is provided with a key placement member 9 shaped like a frame having an opening 8 in which a plurality of key switches 7 are placed.

The second keyboard unit 4 is constructed of a key placement unit 10 and a second base plate 11 made of a metallic, e.g. aluminum, thin plate which is fixed to the undersurface of the key placement unit 10. This key placement unit 10 is provided with a key placement member 14 shaped like a frame having an opening 13 in which a plurality of key switches 12 are placed.

The rotational connecting part 2 is explained below. The key placement member 9 includes a side edge 15 (a right edge in FIG. 1) in which bearing members 17 and 18 partially constituting the rotational connecting part 2 are formed at two corners 16 respectively. The bearing member 17 is provided with two bearings 17B spaced apart, each having a bearing hole 17A. The other bearing member 18 is similarly provided with two bearings 18B spaced apart, each having a bearing hole 18A.

The key placement member 14 includes a side edge 19 (a left edge in FIG. 1) in which bearing members 21 and 22 partially constituting the rotational connecting part 2 are formed at two corners 20 respectively. The bearing member 21 is provided with a single bearing 21B having a bearing hole 21A. The other bearing member 22 is similarly provided with a single bearing 22B having a bearing hole 22A. The bearing 21B is fit in between the bearings 17B so that the bearing holes 17A of the bearing 17B are axially aligned with the bearing hole 21A of the bearing 21B. The bearing 22B is fit in between the bearings 18B so that the bearing holes 18A of the bearing 18B are axially aligned with the bearing hole 22A of the bearing 22B. In the aligned bearing holes 17A and 21A, a support shaft 23A is mounted. In the aligned bearing holes 18A and 22A, another support shaft 23B is mounted. Thus, the key placement units 5 and 10 are supported to be rotatable with each other through the two shafts 23A and 23B.

In the opening 8 of the key placement member 9 in the first keyboard unit 3, there are arranged a predetermined number of key switches 7 which will be operated by the left hand of a user. It is to be noted that the number of the key switches 7 for the left hand is determined based on International Standards (ISO 2126 and ISO 2530). In the opening 13 of the key placement member 14 in the second keyboard unit 4, there are arranged a predetermined number of key switches 12 which will be operated by the right hand of a user. Similarly, the number of the key switches 12 for the right hand is determined based on International Standards (ISO 2126 and ISO 2530), which is larger than the number of key switches 7 for the left hand placed in the key placement member 9.

It is to be noted that each of the key switches 7 and 12 includes a structure for guiding a vertical motion of a key top K by means of a pair of link members not shown while maintaining a horizontal state of the key top K. The structures of such key switches 7 and 12 are well known in the art and therefore the explanations thereof are herein omitted.

The key placement member 9 in the first keyboard unit 3 is explained below in detail. This key placement member 9 is formed into an integral frame surrounding the key placement opening 8, including a first frame portion 30 (an upper portion in FIG. 1), a second frame portion 31 (a left portion in FIG. 1), a third frame portion 32 (a lower portion in FIG. 1), and a fourth frame portion 33 (a right portion in FIG. 1).

The first frame portion 30 is of a hollow shape through which a signal line (not shown) runs to connect each key switch 7 in the first keyboard unit 3 to a connector unit 60 mentioned later. The first frame portion 30 is formed with a connector storage recess 34 for storing the connector unit 60, the recess 34 being adjacent to the bearing member 18. In this connector storage recess 34, a screw hole 35 is formed in each opposite spaced inner wall 34A (only one of which is shown in FIGS. 1 and 2). The screw hole 35 will be mentioned later in explanation of the connector supporting structure.

It is to be noted that the connector storage recess 34 is used to store the connector unit 60 in the keyboard 1 in cooperation with a connector storage recess (mentioned later) formed in the key placement member 14 in the second keyboard unit 4 when the first and second keyboard units 3 and 4 are superposed one on top of the other.

The first frame portion 30 is formed, in a side edge adjacent to the connector storage recess 34, with a storage concave portion 36 for storing a pair of support members 80. This concave portion 36 and a back wall 37 provided upright on the back edge of the first base plate 6 constitute in combination a support member storage part. The thus constituted support member storage part is used in cooperation with another support member storage part similarly formed in the key placement member 14 of the second key board unit 4 to store the pair of support members 80 in a folded state, the support members 80 being folded in synchronization with the folding of the keyboard 1 (the first and second keyboard units 3 and 4).

The second frame 31 is formed with a release button 38 centrally located on the upper surface and two locking hooks 39 provided on both sides of the release button 38. When the first and second keyboard units 3 and 4 are superposed one on top of the other, the release button 38 is held in a recess (mentioned later) formed in the key placement member 14 in the second keyboard unit 4. Each locking hook 39 is engaged in each hole (mentioned later) formed in the key placement member 14. Thus, the first and second keyboard units 3 and 4 can be held in the superposed state without opening unexpectedly.

The fourth frame 33 is integrally provided with a gear teeth part 40 arcuately formed in an upper portion of the side edge 15. These gear teeth part 40 is engaged with a gear teeth part (mentioned later) formed in the key placement member 14 in the second keyboard unit 4.

Next, the key placement member 14 in the second keyboard unit 4 is explained in detail. This key placement member 14 is formed into an integral frame surrounding the opening 13, including a first frame portion 41 (an upper portion in FIG. 1), a second frame portion 42 (a right portion in FIG. 1), and a third frame portion 43 (a lower portion in FIG. 1), and a fourth frame portion 44 (a left portion in FIG. 1).

The first frame portion 41 is of a hollow shape through which a signal line (not shown) runs to connect each key switch 12 in the second keyboard unit 4 to the connector unit 60 mentioned later. The first frame portion 41 is formed with a connector storage recess 45 for storing the connector unit 60, the recess 45 being adjacent to the bearing member 20. In this connector storage recess 45, a screw hole 46 is formed in each opposite spaced inner wall 45A (only one of which is shown in FIGS. 1 and 2). The screw hole 46 will be mentioned later in explanation of the connector supporting structure. Furthermore, a stop projection 47 is formed on each inner wall 45A adjacent to each screw hole 46. The function of this stop projection 47 will be explained later in association with the connector supporting structure.

It is to be noted that the connector storage recess 45 is used, in conjunction with the connector storage recess 34 formed in the key placement member 9 in the first keyboard unit 3, to store the connector unit 60 in the keyboard 1 when the first and second keyboard units 3 and 4 are superposed one on top of the other to fold the keyboard 1.

The first frame portion 41 is formed, in a side edge adjacent to the connector storage recess 45, with a storage concave portion 48 for storing a pair of the support members 80. This concave portion 48 and a back wall 49 provided upright on the back edge of the second base plate 11 constitute in conjunction the support member storage part. The thus constituted storage part for the support members 80 is used in conjunction with the storage part similarly formed in the key placement member 9 of the first key board unit 3 to store the pair of support members 80 in a folded state, the support members 80 being folded in synchronization with the folding of keyboard 1 (the first and second keyboard units 3 and 4).

The second frame 42 is formed with a recess 50 centrally located on the upper surface and two locking holes 51 provided on both sides of the recess 50. When the first and second keyboard units 3 and 4 are superposed one on top of the other, as mentioned above, the release button 38 is held in the recess 50 and each locking hook 39 is engaged in each hole 51. Thus, the first and second keyboard units 3 and 4 can be held in the superposed state without opening unexpectedly.

The fourth frame 44 is integrally formed with a gear teeth part 52 arcuately formed in an upper portion of the side edge 19. These gear teeth part 52 is engaged with the gear teeth part 40 formed in the key placement member 9 in the first keyboard unit 3.

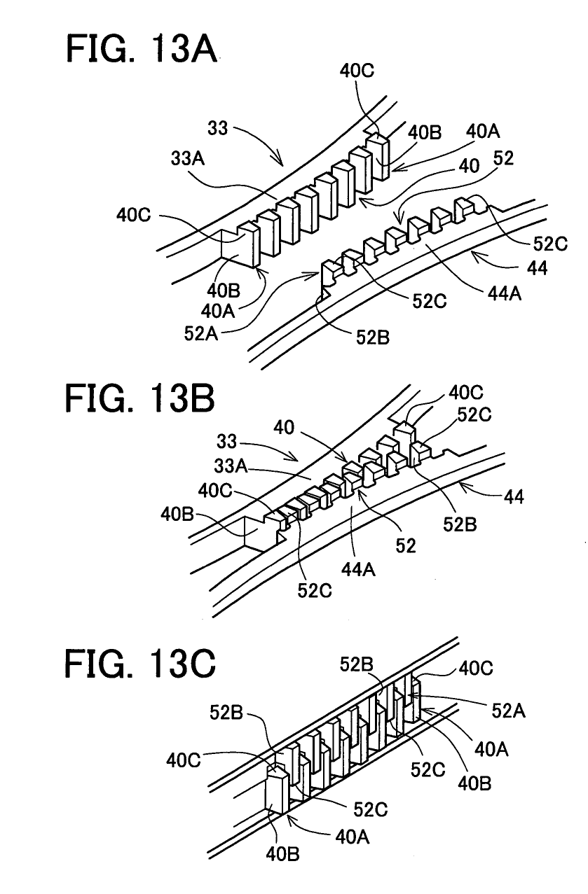

The following explanation is made on a detailed structure of the gear teeth part 40 in the fourth frame 33 of the key placement member 9 and the gear teeth part 52 in the fourth frame 44 of the key placement member 14, referring to FIGS. 13A-13C showing enlarged views of the gear teeth parts 40 and 52. FIG. 13A shows the gear teeth parts 40 and 52 in separate relation for convenience of explanation; FIG. 13B shows the gear teeth parts 40 and 52 in engaged relation; and FIG. 13C shows the gear teeth parts 40 and 52 in engaged relation while the first and second keyboard units 3 and 4 are superposed one on top of the other in the folded keyboard 1.

In FIG. 13A, the gear teeth part 40 in the fourth frame 33 of the key placement member 9 is constructed of a plurality of gear teeth 40A arranged in arcuate relation. Each gear tooth 40A is formed of a gear portion 40B existing below an upper surface 33A of the fourth frame 33 and a gear portion 40C continuously formed from the gear portion 40B so as to protrude above the upper surface 33A. The gear teeth part 52 in the fourth frame 44 of the key placement member 14 is constructed of a plurality of gear teeth 52A arranged in arcuate relation. Each gear tooth 52A is formed of a gear portion 52B existing below an upper surface 44A of the fourth frame 44 and a gear portion 52C continuously formed from the gear frame 52B so as to protrude above the upper surface 44A.

While the gear teeth parts 40 and 52 are engaged with each other, as shown in FIG. 13B, the gear portions 40C of the gear teeth 40A and the gear portions 52C of the gear teeth 52A are engaged with each other even above the upper surface 33A of the fourth frame 33 and the upper surface 44A of the fourth frame 44.

This engagement relation allows the gear teeth 40A of the gear teeth part 40 and the gear teeth 52A of the gear teeth part 52 to be engaged with each other in every state of a sequence from a superposed state of the first and second keyboard units 3 and 4 (a folded state of the keyboard 1) to a horizontally arranged state (an unfolded, usable state of the keyboard 1) as shown in FIGS. 13A to 13C.

Next, referring to FIGS. 1 and 2, explanations are made on the supporting structure of the connector unit 60 and the supporting structure of the support members 80 which support a portable device such as a PDA.

At first, the supporting structure of the connector unit 60 is described. In FIG. 2, screw holes 61 (only a front one is shown) are formed in both front and back sides of the connector unit 60 at one end (a right end in FIG. 2). A screw 64 is threaded into each screw hole 61 through a hole 63 formed at an upper end of each support link 62. On the other hand, a screw 66 is threaded, after passing through a hole 65 formed at a lower end of each support link 62, into the screw hole 35 in each inner wall 34A of the connector storage recess 34 formed in the first frame 30 of the key placement member 9 in the first keyboard unit 3.

Screw holes 67 (only a front one is shown) are formed in both front and back sides of the connector unit 60 at the other end (a left end in FIG. 2). A screw 70 is threaded into each screw hole 67 through a hole 69 formed at an upper end of each support link 68 (having a length slightly shorter than that of the support link 62). A screw 72 is threaded, after passing through a hole 71 formed at a lower end of each support link 68, into the screw hole 46 in each inner wall 45A of the connector storage recess 45 formed in the first frame 41 of the key placement member 14 in the second keyboard unit 4.

The connector unit 60 having the above supporting structure can be moved, by the pivoting motion of each support link 62 and 68, between the connector storage recess 34 in the first keyboard unit 3 and the connector storage recess 45 in the second keyboard unit 4 to unfold the keyboard 1 (the first and second keyboard units 3 and 4) from the folded state, or vise versa.

It is to be noted that the length of each support link 62 pivotally connected to the connector storage recess 34 is designed to be longer than each support link 68 pivotally connected to the other connector storage recess 45 so that a distance between the rotational connecting part 2 and each screw hole 35 in the connector storage recess 34 differs from a distance between the connecting part 2 and each screw hole 46 in the connector storage recess 45. This is to prevent each support link 62 and each support link 68 from overlapping each other when the first and second keyboard units 3 and 4 are superposed.

In the superposed state of the first and second keyboard units 3 and 4, namely, in the folded state of the keyboard 1, the connector unit 60 with a connector facing upwards is stored in the connector storage recess 34 in the first keyboard unit 3. As the first and second keyboard units 3 and 4 are gradually opened, the connector unit 60 is moved from the storage recess 34 in the first keyboard unit 3 toward the storage recess 45 in the second keyboard unit 4 by the pivoting motions of the support links 62 and 68. When the first and second keyboard units 3 and 4 are opened into a horizontal position, a long side edge of each support link 68 engages against each stop projection 47 in the storage recess 45. In this state where the long side edge of each support link 68 engages against each stop projection 47, the connector unit 60 can stably be supported at a position where a center axis (perpendicular to a long side) of the connector unit 60 is substantially placed above the rotational connecting part 2.

Next explanation is made on the supporting structure, provided over the back sides of the first and second keyboard units 3 and 4, of the support members 80 to support a portable device such as a PDA.

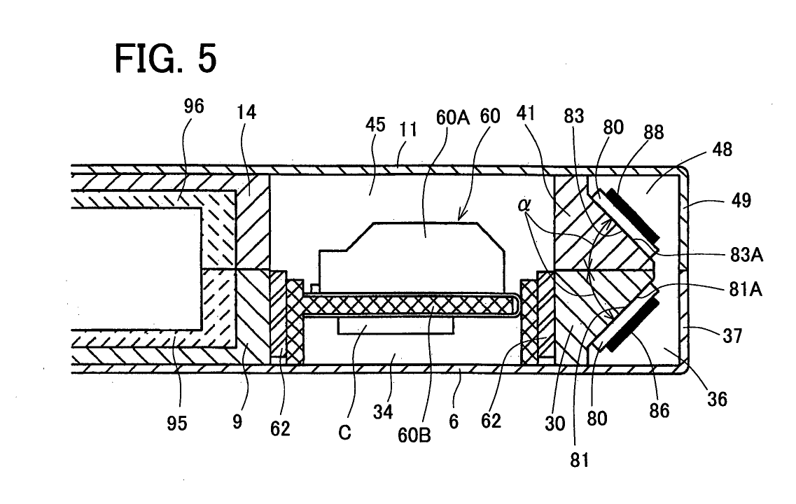

In the first keyboard unit 3, a support wall 81 is provided on the back side of the connector storage recess 34. This support wall 81 includes a slant face 81A (see FIG. 5) facing downwards at an angle of 45° with respect to a key operating plane (a horizontal plane) in the horizontally arranged first and second keyboard units 3 and 4 during use of the keyboard 1. The support wall 81 is formed with a screw hole 82.

In the second keyboard unit 4, similarly, a support wall 83 is provided on the back side of the connector storage recess 45. This support wall 83 includes a slant face 83A (see FIG. 5) facing downwards at an angle of 45° with respect to the key operating plane (the horizontal plane) in the horizontally arranged first and second keyboard units 3 and 4 during use of the keyboard 1. The support wall 83 is formed with a screw hole 84.

Each support member 80 includes a flat rod 80A and a bent portion 80B bent from the flat rod 80A, which are integrally made of a metallic plate. This bent portion 80B serves to increase the rigidity of the support member 80.

In one (a right one in FIG. 2) of the support members 80, a through hole 85 is formed in a lower end of the flat rod 80A. A screw 86 passes through this through hole 85 and is threaded into the screw hole 82. Similarly, in the other support member 80 (a left one in FIG. 2), a through hole 87 is formed in a lower end of the flat rod 80A. A screw 88 passes through this through hole 87 and is threaded into the screw hole 84.

In the former support member 80, a through hole 89 is formed in an upper end of the flat rod 80A. A locking pin 90 passes through the through hole 89 and is fixed to one plate part 92A (a right one in FIG. 2) of a hinge joint 92 having a hinge rod 91. Similarly, in the latter support member 80, a through hole 93 is formed in an upper end of the flat rod 80A. A locking pin 94 passes through the through hole 93 and is fixed to the other plate part 92B (a left one in FIG. 2) of the hinge joint 92.

Accordingly, the lower ends of both support members 80 are pivotally connected to the slant face 81A of the support wall 81 and the slant face 83A of the support wall 83 respectively. The upper ends of both support members 80 are pivotally connected to the two plate parts of the hinge joint 92 respectively. It is also obvious that the plate parts of the hinge joint 92 which turnably, hingedly, support the upper ends of the support members 80 can be turned about the rod 91.

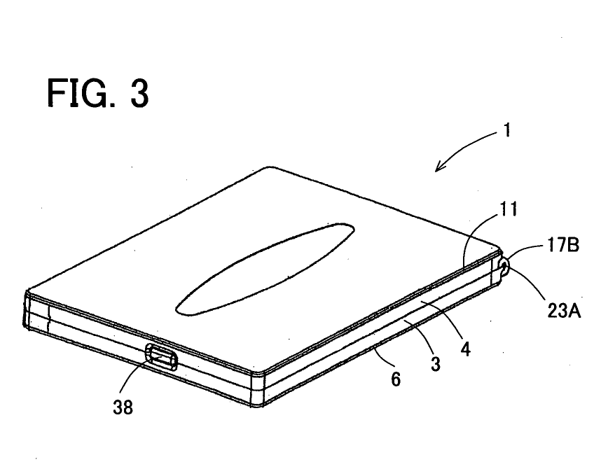

Referring to FIGS. 3 through 11, explanations are made on the motion of the above supporting structure of the connector unit 60 and the above supporting structure of the support members 80 which support the portable device such as a PDA in relation to the opening and closing operations of the first and second keyboard units 3 and 4.

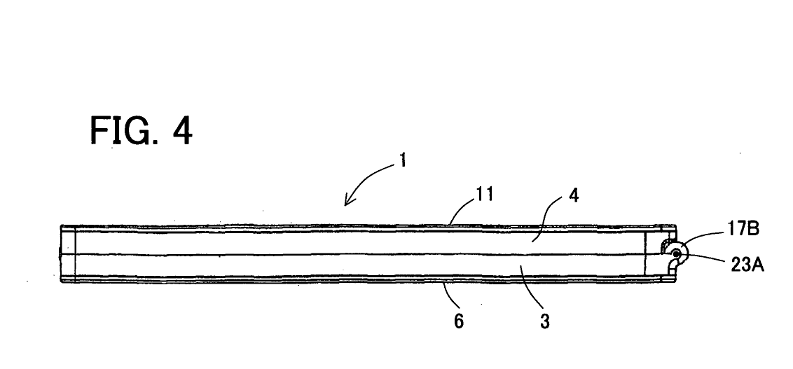

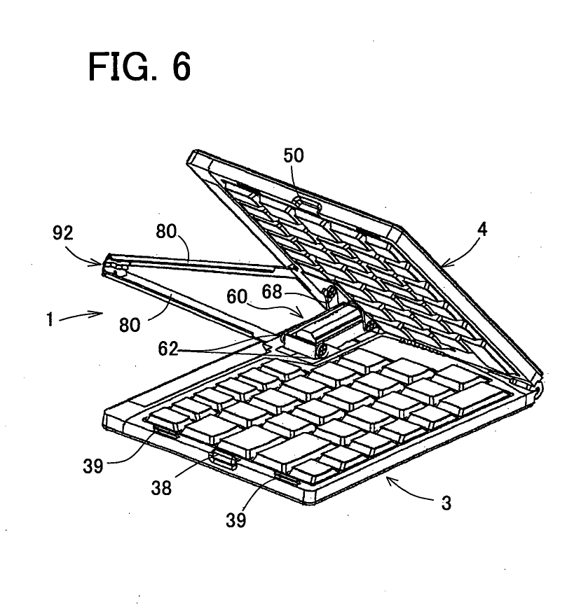

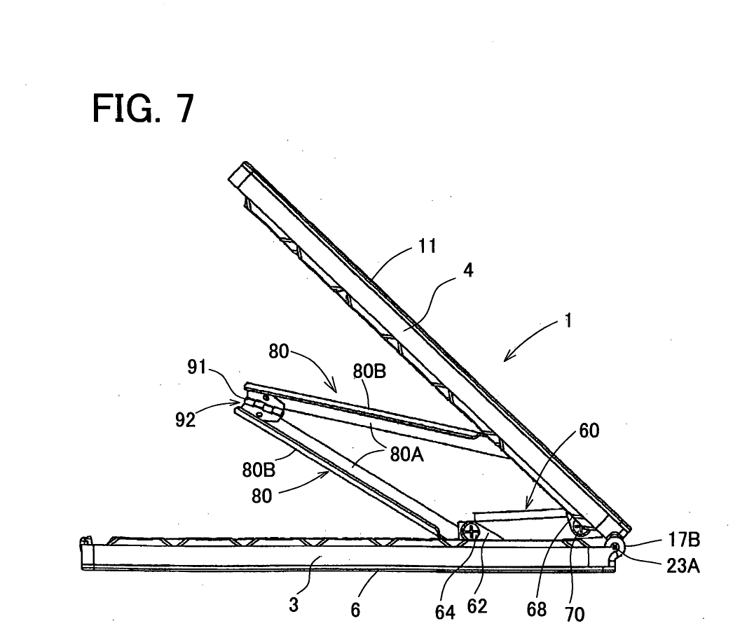

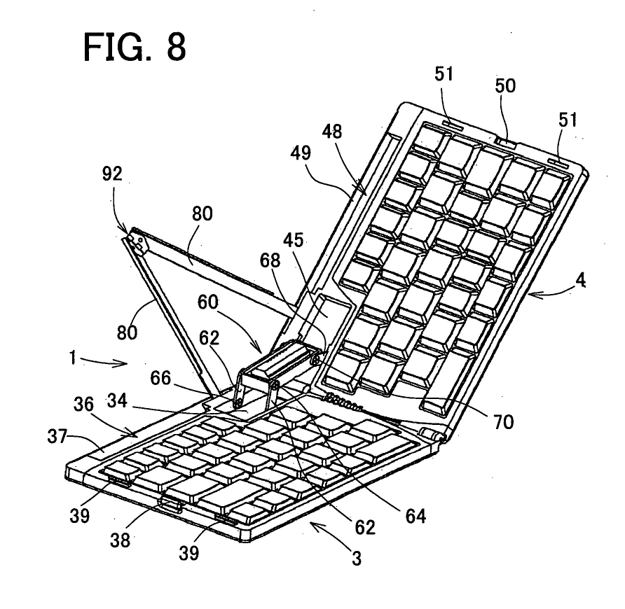

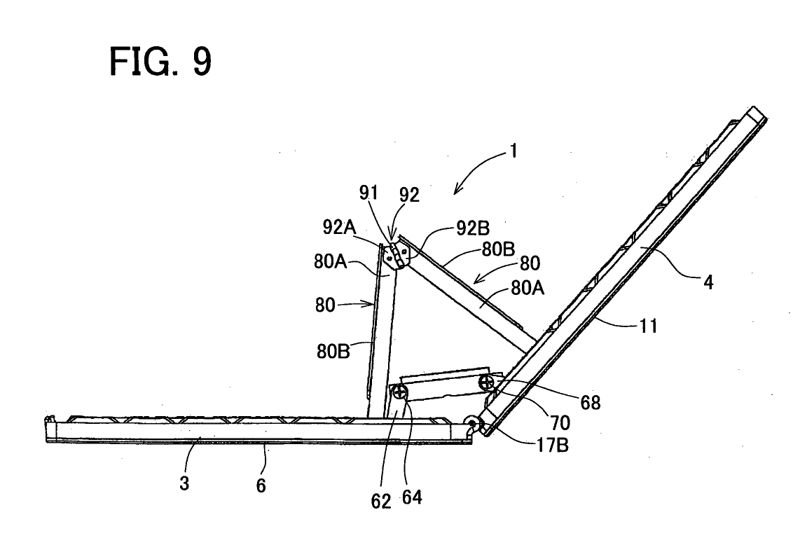

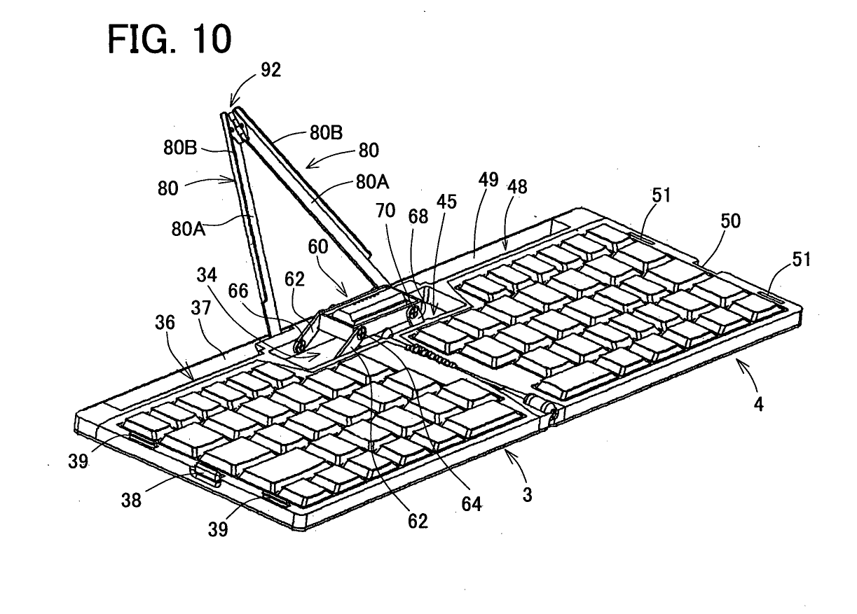

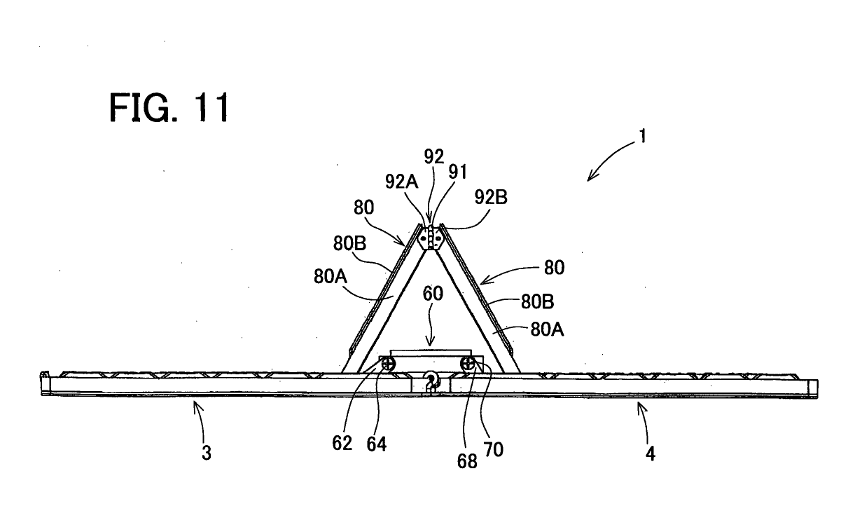

FIG. 3 is a perspective view of the keyboard 1 in which the first and second keyboard units 3 and 4 are superposed; FIG. 4 is a side view of the keyboard 1 of FIG. 3; FIG. 5 is a partial, enlarged sectional view of the keyboard 1 of FIG. 3; FIG. 6 is a perspective view of the keyboard 1 in which the first and second keyboard units 3 and 4 are slightly opened; FIG. 7 is a side view of the keyboard 1 of FIG. 6; FIG. 8 is a perspective view of the keyboard 1 in which the first and second keyboard units 3 and 4 are further opened from the state in FIG. 6; FIG. 9 is a side view of the keyboard 1 of FIG. 8; FIG. 10 is a perspective view of the keyboard 1 in which the first and second keyboard units 3 and 4 are fully opened into a horizontal position; and FIG. 11 is a side view of the keyboard 1 of FIG. 10.

In the folded state of the keyboard 1 with the first and second keyboard units 3 and 4 being superposed one on top of the other, the two locking hooks 39 in the second frame 31 of the key placement member 9 are engaged in the locking holes 51 in the second frame 42 of the key placement member 14 and also the release button 38 positioned between the locking hooks 39 is inserted in the recess 50 formed between the locking holes 51. Thus, the first and second keyboard units 3 and 4 are stably held in the folded state of the keyboard 1 as shown in FIGS. 3 and 4.

The storage of the connector unit 60 and the support members 80 in the folded keyboard is explained below with reference to FIG. 5. Specifically, the following explanation is made on how the connector unit 60 is stored in the storage recesses 34 and 45 and how the support members 80 are stored in the support member storage part constructed of the storage concave portion 36 and the back wall 37 of the first base plate 6 and in the other support member storage part constructed of the storage concave portion 48 and the back wall 49 of the second base plate 11.

In FIG. 5, the connector unit 60 includes a connector 60A and a connector supporting member 60B mounting thereon the connector 60A and being of an H-shaped cross section. This connector unit 60 is substantially received in the storage recess 34 in the first frame 30 of the key placement member 9 in the first keyboard unit 3. A part of the connector 60A protruding upwards from the storage recess 34 is received in the other storage recess 45 in the first frame 41 of the key placement member 14 in the second keyboard unit 4.

On the undersurface of the connector supporting member 60B, as shown in FIG. 5, a controller C (IC) which controls the whole keyboard 1 is mounted. Since the controller C is placed on the undersurface of the connector supporting member 60B, the controller C together with the main part of the connector 60A can be stored in the connector storage recess 34. As compared with a case where the controller C is placed outside of the keyboard, the keyboard 1 in the present embodiment can provide a compact size and a good appearance.

On the support wall 81 formed on the back side of the first frame 30 in the first keyboard unit 3, one of the support members 80 is pivotally supported about the screw 86. On the support wall 83 formed on the back side of the first frame 41 in the second keyboard unit 4, the other support member 80 is pivotally supported about the screw 88. In this state, the support members 80 are folded and stored in the support member storage parts in the first and second keyboard units 3 and 4.

The angle α between the upper surface of the first frame 30 of the key placement member 9 and the slant face 81A of the support wall 81 is set at 45°. Similarly, the angle α between the lower surface of the first frame 41 of the key placement member 14 and the slant face 83A of the support wall 83 is set at 45° Accordingly, the angle between the slant faces 81A and 83A is 90° as shown in FIG. 5, so that the angle between the flat rods 80A of the support members 80 is 90°.

As shown in FIG. 5, the key placement member 9 is internally provided with a metallic support plate 95 which supports each key switch 7 and the key placement member 14 is internally provided with a metallic support plate 96 which supports each key switch 12.

As the second keyboard unit 4 is gradually rotated about the rotational connecting part 2 in a direction which the unit 4 comes apart from the first keyboard unit 3, the connector unit 60 is moved upwards by the pivoting motions of the support links 62 and 68, in synchronization with the rotation of the second keyboard unit 4, as shown in FIGS. 6 and 7. Simultaneously, each support member 80 is moved to be gradually unfolded from the folded state.

At this time, the lower end of one of the support members 80 is pivotally connected to the slant face 81A of the support wall 81 and the lower end of the other support member 80 is pivotally connected to the slant face 83A of the support wall 83. In addition, the upper end of the former support member 80 is pivotally connected to the one plate part 92A of the hinge joint 92 and the upper end of the latter support member 80 is pivotally connected to the other plate part 92B of the hinge joint 92. The former support member 80 is pivoted in a plane including the slant face 81A and the latter support member 80 is pivoted in a plane including the slant face 83A. Furthermore, the upper ends of the support members 80 are caused to turn about the rod 91 by the movement of the hinge joint 92, which gradually increases the angle (90°) between the flat rods 80A of the support members 80.

When the second keyboard unit 4 is further rotated, as shown in FIGS. 8 and 9, the connector unit 60 is further moved up and the support members 80 are further opened while pivoting. At this time, in the same manner as above, one of the support members 80 is pivoted in the plane including the slant face 81A and the other support member 80 is pivoted in the plane including the slant face 83A. Simultaneously, the upper ends of the support members 80 are further turned about the rod 91 of the hinge joint 92. Thus, the angle between the flat rods 80A for the support members 80 is further increased and the flat rods 80A gradually becomes flush with each other.

At the time when the keyboard 1 is completely opened, in which the first and second keyboard units 3 and 4 are horizontally arranged, the side edges of the support links 68 engage against the stop projections 47 formed on the inner walls 45A of the storage recess 45. In this state, the center axis of the connector unit 60 is positioned above the connecting part 2 and therefore the connector unit 60 is disposed in a substantial center position of the keyboard 1.

The slant face 81A of the support wall 81 in the first keyboard unit 3 and the slant face 83A of the support wall 83 in the second keyboard unit 4 become flush with each other in the slant plane facing downward at an angle of 45° with the key operating plane (the horizontal plane). Hence, the support members 80 are set up in a standing orientation tilting at an angle of 45° with the operating plane of the keyboard 1, as shown in FIGS. 10 and 11. Concurrently, the upper ends of the support members 80 are further turned about the rod 91 by the movement of the hinge joint 92, increasing the angle between the flat rods 80A of the support members 80 to 1800. Thus, the flat rods 80A become flush (with the slant face including the slant faces 81A and 83A).

As described above, in the superposed state of the first and second keyboard units 3 and 4 in the folded keyboard 1, the flat rods 80A of the support members 80 are held at a predetermined angle (90°), not flush. However, when the upper ends of the support members 80 are turned about the rod 91 of the hinge joint 92 in synchronization with the further rotation of the first and second keyboard units 3 and 4 into a horizontally opened state, the flat rods 80A of the support members 80 become flush with each other. The end surfaces of the bent portions 80B bent from the flat rods 80A correspondingly become flush with each other.

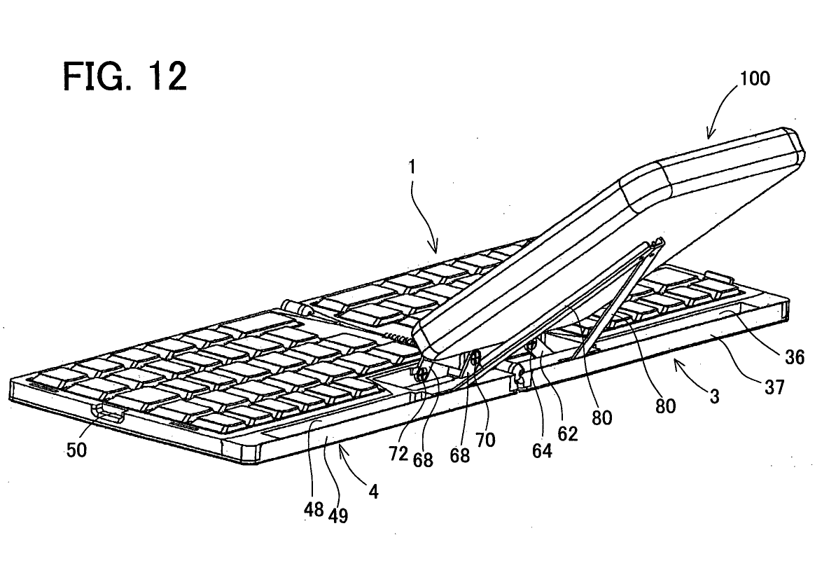

To input data in the PDA with the use of the keyboard 1 unfolded as above by fully opening the first and second keyboard units 3 and 4 into a horizontally arranged state, a contact terminal of the PDA 100 is first connected with a contact terminal of the connector 60A of the connector unit 60 as shown in FIG. 12. Then, the PDA 100 is set on the support members 80. In this state, the data input or the like in the PDA 100 can be performed with the use of the key switches 7 and 12 provided in the keyboard 1.

As explained above, the foldable keyboard 1 in the present embodiment includes the following structures. Both sides of the connector unit 60 at one end portion are connected to the inside walls 34A of the connector storage recess 34 by means of the two support links 62. Both sides of the connector unit 60 at the other end portion are connected to the inside walls 45A of the connector storage recess 45 by means of the two support links 68. In the superposed state of the first and second keyboard units 3 and 4, the connector unit 60 is stored in the storage recesses 34 and 45. At the time when the first and second keyboard units 3 and 4 are completely opened to be horizontally arranged, the long side edges of the support links 68 engage the stop projections 47 formed on the inner walls 45A of the connector storage recess 45, thus centrally placing the connector unit 60 in the keyboard 1. Accordingly, the connector unit 60 can automatically be placed in a substantial center position of the keyboard 1 in synchronization with the operation to open the first and second keyboard units 3 and 4 into the horizontally arranged state.

In particular, the support links 68 engage against the stop projections 47 formed in the connector storage recess 45 in the second keyboard unit 4 at the time when the first and second keyboard units 3 and 4 are opened into the horizontally arranged state. Thus, the connector unit 60 can be placed in a substantial center position of the keyboard 1 by a very easy operation of rotating the first and second keyboard units 3 and 4 until the support links 68 engage against the stop projections 47 respectively.

The stop projections 47 push the support links 68 engaging against the projections 47 when the first and second keyboard units 3 and 4 are rotated in a direction which they come close to each other, thereby closing the keyboard 1. At this time, the projections 47 restrict the pivotal direction of the support links 68, making it possible to surely store the connector unit 60 in the connector storage recesses 34 and 45.

In the state where the connector unit 60 is placed in a substantial center position of the keyboard 1, the contact terminal of the connector 60A is exposed outside at the upper surface thereof. Accordingly, the above very simple one-touch operation of unfolding the first and second keyboard units 3 and 4 can establish connection between the contact terminal of the PDA 100 and the terminal of the connector 60A to bring the PDA 100 in a usable condition.

Furthermore, the contact unit 60 is constructed to be stored in the connector storage recesses 34 and 45 in the first and second keyboard units 3 and 4 when the keyboard 1 is folded. Hence, the connector unit 60 can be prevented from being exposed outside during carrying or transport of the keyboard 1. This makes it possible to reduce the size of the keyboard 1 and enhance the appearance.

The lower end of one of the two support members 80 is pivotally connected to the support wall 81 including the slant face 81A in the first keyboard unit 3 and the upper end is pivotally connected to one plate part 92A of the hinge joint 92 and turnably about the hinge rod 91. Similarly, the lower end of the other support member 80 is pivotally connected to the support wall 83 having the slant face 83A in the second keyboard unit 4 and the upper end is pivotally connected to the other plate part 92B of the hinge joint 92 and turnably about the rod 91. The support members 80 are put in the support member storage part in the first and second keyboard units 3 and 4 of the folded keyboard 1 and, on the other hand, are set up in a standing orientation tilting at an angle of 45° with the operating plane of the keyboard 1 when the first and second keyboard units 3 and 4 are completely opened into the horizontally arranged state. Simultaneously, the flat rods 80A of the support members 80 become flush with each other by the movement of the hinge joint 92. With the above structures, in synchronization with the operation of unfolding the first and second keyboard units 3 and 4, the display of the PDA 100 connected with the keyboard 1 can stably be held in a tilting state at an easily viewable angle.

At the time when the first and second keyboard units 3 and 4 are opened into the horizontally arranged state, the support members 80 are set up, in the substantial center of the keyboard 1, in the standing orientation tilting at an angle of 45° with the operating plane of the keyboard 1. Consequently, by the very simple operation of unfolding the first and second keyboard units 3 and 4, the support members 80 can be set in the proper positions for supporting the PDA 100 through one-touch operation.

Furthermore, the support members 80 are constructed to be stored in the support member storage part in the first and second keyboard units 3 and 4 of the folded keyboard 1. Thus, the support members 80 can be prevented from being exposed outside during carrying or transport of the keyboard 1. This makes it possible to provide the keyboard 1 with a compact size and a good appearance.

The present invention may be embodied in other specific forms without departing from the spirit or essential characteristics thereof.

For instance, in the above embodiment, the upper ends of the support members 80 are hingedly connected to each other by the hinge joint 92 on both sides of the hinge rod 91. Alternatively, without the use of the hinge joint 92, the support members 80 may be directly pivotally interconnected at the upper ends. Instead of the hinge joint 92, a connecting flat plate may be used to pivotally support the upper ends of the support members 80 on both sides of the connecting plate. In these cases, the above mentioned movement of the hinge joint 92 is absent and therefore the support walls in the first and second keyboard units 3 and 4 which pivotally support the lower ends of the support members 80 have to be formed perpendicular to the key operating plane.

In the above embodiment, the slant faces 81A and 83A of the support walls 81 and 83 which support the lower ends of the support members 80 are configured to form an angle of 45° with respect to the key operating plane. These slant faces 81A and 83A may be formed at any angle suitable for viewing the display of the PDA 100 held by the support members 80.

In the above embodiment, furthermore, the stop projections 47 are formed in the connector storage recess 45 in the second keyboard unit 4. An alternative design is to form the stop projections 47 in the connector storage recess 34 in the first keyboard unit 3. In this case, the connector unit 60 is first stored, with the contact terminal facing upwards, in the connector storage recess 45 in the second keyboard unit 4 in the folded keyboard 1 and then moved toward the connector storage recess 34 when the first and second keyboard units 3 and 4 are rotated into the horizontal position.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A foldable keyboard including a first keyboard unit, a second keyboard unit, and a rotational connecting part provided between the first and second keyboard units, so that the first and second keyboard units are rotated about the connecting part to come apart from each other into an unfolded, horizontally arranged state for use of the keyboard, while the first and second keyboard units are rotated about the connecting part to come close to each other into a closed, folded state for nonuse of the keyboard, the keyboard including:
a first support member having a first end and a second end, the first end being pivotally connected to a back wall of the first keyboard unit;
a second support member having a first end and a second end, the first end being pivotally connected to a back wall of the second keyboard unit;
wherein the second ends of the first and second support members are pivotally connected with each other, and the first and second support members are set up in a standing orientation in synchronization with the rotation of the first and second keyboard units in a direction which they come apart from each other.

2. The foldable keyboard according to claim 1, wherein the back wall of the first keyboard unit includes a first slant face and the back wall of the second keyboard unit includes a second slant face,
the first and second slant faces are tilted at a predetermined angle to an operating plane of the keyboard in use, and
the first and second support members are set up in a standing orientation tilting at the predetermined angle to the operating plane of the keyboard when the first and second keyboard units are rotated into the horizontally arranged state.

3. The foldable keyboard according to claim 2 further including a joint plate which pivotally supports the second ends of the first and second support members.

4. The foldable keyboard according to claim 3, wherein the joint plate includes a hinge structure including two plate parts and a rod turnably connecting the two plate parts with each other, and
the second end of the first support member is pivotally connected to one of the plate parts and the second end of the second support member is pivotally connected to the other plate part.

5. The foldable keyboard according to claim 1, wherein the first and second keyboard units are provided, on respective back portions symmetrically about the rotational connecting part, with storage parts for storing the first and second support members in a folded state when the first and second keyboard units are superposed one on top of the other.

6. A foldable keyboard including a first keyboard unit, a second keyboard unit, and a rotational connecting part provided between the first and second keyboard units, so that the first and second keyboard units are rotated about the connecting part to come apart from each other into an unfolded, horizontally arranged state for use of the keyboard, while the first and second keyboard units are rotated about the connecting part to come close to each other into a closed, folded state for nonuse of the keyboard, the keyboard including:
a connector unit for connecting the keyboard to a portable device;
a first connector storage part formed in the first keyboard unit;
a second connector storage part formed in the second keyboard unit and for storing, in conjunction with the first connector storage part, the connector unit;
a first support link which connects the first connector storage part to the connector unit;
a second support link which connects the second connector storage part to the connector unit;
wherein the connector unit is moved toward the rotational connecting part from the first and second connector storage parts in synchronization with rotation of the first and second keyboard units in a direction which they come apart from each other, and the connector unit is placed above the rotational connecting part in a substantial center of the keyboard when the first and second keyboard units are rotated into the horizontally arranged state.

7. The foldable keyboard according to claim 6 further including a stop projection formed in one of the first connector storage part and the second connector storage part to engage one of the first support link and the second support link when the first and second keyboard units are rotated,
wherein one of the first support link and the second support link engages against the stop projection when the first and second keyboard units are rotated into the horizontally arranged state.

8. The foldable keyboard according to claim 7, wherein the one of the first support link and the second support link is pushed by the stop projection when the first and second keyboard units are rotated in a direction that they come close to each other.

9. The foldable keyboard according to claim 6, wherein the first and second connector storage parts store, in conjunction, the connector unit when the first and second keyboard units are superposed.
